(19) United States
(12) Patent Application Publication
(10) Pub. No.: US 2025/0205707 A1
(43) Pub. Date: Jun. 26, 2025

(54) DROPLET FORMATION SYSTEM AND METHOD

(71) Applicant: SPHERE FLUIDICS LIMITED, Cambridge, Cambridgeshire (GB)

(72) Inventors: John S MCGRATH, Cambridge, Cambridgeshire (GB); Graeme . WHYTE, Cambridge, Cambridgeshire (GB); Clive A. SMITH, Cambridge, Cambridgeshire (GB)

(21) Appl. No.: 18/848,180

(22) PCT Filed: Mar. 17, 2023
(86) PCT No.: PCT/EP2023/056967

§ 371 Date: Sep. 18, 2024

(30) Foreign Application Priority Data
Mar. 18, 2022 (GB) 2203829.3

(51) Int. Cl. B01L 3/00; G01N 15/0227; G01N 15/14

(52) U.S. Cl. CPC B01L 3/502784; G01N 15/0227; G01N 15/14; B01L 2200/061; G01N 2015/1493

(57) ABSTRACT

A method and system for generating a flow of droplets comprising providing a first droplet fluid, providing a second droplet fluid, providing a carrier fluid and forming a double emulsion of droplets each comprising a first droplet region comprising the first droplet fluid surrounded by a second droplet region comprising the second droplet fluid within the carrier fluid, by providing a flow of said first droplet fluid, a flow of said second droplet fluid, and a flow of said carrier fluid to a droplet generation sub-system of a microfluidic structure. The method comprises determining a dimension of said first droplet region of sequential droplets within the emulsion, determining an outer dimension of said second droplet region of sequential droplets within the emulsion, adjusting a pressure of the flow of the first droplet fluid in response to the determined dimension of the first droplet region, and adjusting a pressure of the flow of the second droplet fluid in response to the determined outer dimension of the second droplet region.

### TECHNICAL FIELD

The present application relates to systems and methods for generating a flow of droplets within a double emulsion.

### BACKGROUND

In this specification we are concerned with double emulsions, typically comprising droplets of an aqueous core region surrounded by an oil sheath region, in water and generally surfactant-stabilised. One or more biological entities such as one or more living cells or particles may be incorporated into the core region of each droplet and then experiments performed within the droplet, for example to perform a biological assay. Droplets can be generated and processed potentially at rates in excess of several thousand per second.

Typically, the oil composition comprises a fluorous and/or mineral oil and, preferably, a surfactant, for example at around 0.5-5% vol/vol. Use of a fluorous oil is particularly advantageous when the microdroplets contain living entities because fluorous oil is good at transporting oxygen to the microdroplets. The surfactant may be either polymeric or small molecule; for example, surfactants derived from block co-polymers of perfluoroethers such as Krytox™ or polyethylene glycol (PEG) may be used. The material or analyte within a microdroplet may comprise, for example, cells, DNA, protein, peptide, beads, particles, crystals, micelles, macromolecules, material for an enzymatic assay, organelles, an organism such as cell for example a mammalian cell, yeast cell, algal cell or bacterium, a virus, a prion and so forth.

Crawford, D. F., Smith, C. A. & Whyte, G. Image-based closed-loop feedback for highly mono-dispersed microdroplet production. Sci Rep 7, 10545 (2017). relates to controlling the size of droplets in a single emulsion. US 2014/338753 A1 relates to a method of producing droplets. Further background material can be found in: US2011/0053798, WO2011/028764, and in the video at: https://www.youtube.com/watch?v=FkmBUapQMHc.

### SUMMARY

Aspects and preferred features are set out in the accompanying claims.

According to a first aspect there is provided a method for generating a flow of droplets, the method comprising:
providing a first droplet fluid;
providing a second droplet fluid;
providing a carrier fluid;
forming a double emulsion of droplets each comprising a first droplet region comprising the first droplet fluid surrounded by a second droplet region comprising the second droplet fluid within the carrier fluid, by providing a flow of said first droplet fluid, a flow of said second droplet fluid, and a flow of said carrier fluid to a droplet generation sub-system of a microfluidic structure;
determining a dimension of said first droplet region of sequential droplets within the emulsion;
determining an outer dimension of said second droplet region of sequential droplets within the emulsion;
adjusting a pressure of the flow of the first droplet fluid in response to the determined dimension of the first droplet region; and
adjusting a pressure of the flow of the second droplet fluid in response to the determined outer dimension of the second droplet region.

The first droplet region may be referred to as the inner droplet region or core, and the second droplet region may be referred to as the outer droplet region or sheath.

This method provides double-emulsion droplet generation with real-time determination of a dimension of both the first and second droplet regions, and closed-loop feedback control of the droplet region dimensions. The method maintains the monodispersity of the flow of droplets by controlling the pressure of the flow of the first droplet fluid and/or the flow of the second droplet fluid in response to the determined droplet dimension. This can be used to ensure that the size of the inner droplet region and outer droplet region is substantially constant between sequential droplets, to produce a flow of droplets having homogenous inner and outer droplet regions.

Forming the double emulsion of droplets may comprise providing the first droplet fluid and the second droplet fluid to a first droplet generation region of the droplet generation sub-system to form a single emulsion, and providing the single emulsion and the carrier fluid to a second droplet generation region of the droplet generation sub-system. The term fluid may be herein used to refer to a liquid.

The method may comprise varying a pressure of the flow of the first droplet fluid, varying a pressure of the flow of the second droplet fluid, and/or varying a pressure of the flow of said carrier fluid such that a determined dimension of said first droplet region or a determined outer dimension of said second droplet region is substantially constant between sequential droplets.

During a starting time period of the method of generating a flow of droplets, the method may comprise directing the flow of droplets to a waste channel in response to said determined outer dimension of said second droplet region being outside a predetermined droplet dimension range. When the instrument is started-up, there may be a period of time where the double-emulsion droplets that are being generated do not meet the specified user's overall size requirements. Whilst the droplets that are being generated do not meet the specified user's size requirements, this would allow these droplets to travel to the waste channel.

When the correct overall droplet size is achieved, droplets may be prevented from going to waste and instead may be collected. This may be performed by closing a valve on the waste channel. The valve may be programmed to close over a predetermined time period. By closing the valve of the waste channel relatively slowly, this allows the system to compensate for the increased back pressure in the system without the droplet volume changing.

Determining a dimension of said first droplet region or determining an outer dimension of said second droplet region may comprise determining a dimension from a captured image of the droplet.

The term dimension may be herein used to refer to a physical width or length of the droplet within a microfluidic droplet channel.

The method may further comprise detecting a droplet of the flow of droplets within a microfluidic droplet channel, and upon detection of the droplet, capturing an image of the droplet using a camera to provide the captured image of the droplet.

Detecting a droplet within the flow of droplets may comprise illuminating the flow of droplets within the microfluidic droplet channel; using a beam splitter to split light from the flow of droplets into a first portion and a second portion, where the first portion may comprise light above a predetermined threshold wavelength and where the second portion may comprise light below a predetermined threshold wavelength; directing the first portion to the camera for capturing an image of the droplet using the camera; directing the second portion through an aperture located in front of a photodetector to the photodetector; and processing a signal from the photodetector to provide a processed signal for detecting a droplet of the flow of droplets within a microfluidic droplet channel, and determining a droplet frequency from fluctuations in the processed signal.

The processed signal from the photodetector may also be used for triggering the camera.

Processing the signal from the photodetector may comprise obtaining and processing a photodetector output voltage signal over a given period to identify voltage signal differences which correspond with differences in optical characteristics exhibited at interfaces between the first droplet fluid, the second droplet fluid, and the carrier fluid as droplets pass a detection region of the microfluidic droplet channel.

The herein disclosed method provides an automated method of determining droplet frequency of a flow of microfluidic double-emulsion droplets. By directing the second portion through an aperture located in front of a photodetector, the sensitivity of the photodetector is improved.

The method may further comprise detecting a droplet using the processed signal, and upon detection of the droplet, simultaneously capturing an image of the droplet using the camera. This uses the output of the detected photodetector signal to actively trigger the camera, via a microprocessor or analogue electronics, to automatically image droplets within the microfluidic channel.

The microprocessor camera triggering algorithm may further allow the individual droplet detection incidences to be counted over a set period of time, or until the last image was captured, to establish droplet frequency.

Detecting a droplet within the flow of droplets may comprise detecting scattered light from the second portion at the photodetector, where the scattered light may have been scattered by an interface between the carrier fluid and second droplet region or scattered by an interface between the first droplet region and the second droplet region.

Determining the droplet dimension may comprise identifying a centre of the first droplet region and a centre of the second droplet region within the captured image of the flow; fitting a first closed curve to an outside edge of the first droplet region in the captured image of the flow; determining a first interest region in the captured image of the flow, where the first interest region may comprise the centre of the first droplet region and where a perimeter of the first interest region may correspond to the first closed curve; fitting a second closed curve to an outside edge of the second droplet region in the captured image of the flow; determining a second interest region in the captured image of the flow, where the second interest region may comprise the centre of the second droplet region and where a perimeter of the second interest region may correspond to the second closed curve; and determining the droplet dimension by processing the first interest region and the second interest region of the captured image. To determine the droplet dimension or length, the method may comprise comparing the size (e.g. number of pixels) of the first interest region or the second interest region against a known physical size of each pixel within the processed line region. The known size of each pixel could alternatively be termed as the number of pixels required to display a given physical length. In other words, the physical length or size of the interest region can be determined by knowing the number of pixels per inch (or per centimeter) in the captured image. This resolution of the captured image can be determined by knowing the resolution of the sensor or camera together with the dimension of field of view.

Alternatively, the physical size can be estimated with known actual distance between the camera and the droplet, focal length, number of pixel of the line region and the pixel pitch of the camera.

The closed curves corresponding to the boundaries can be overlaid on the captured camera image in real-time to enable visual confirmation of droplet detection by the user. The closed-curves can be used to determine radii data of the first and second droplet regions, which can be used to calculate the size or volume of the first and second droplet regions respectively, which can in turn be used to as an input to other downstream processes.

The method may further comprise calculating a volume of the first droplet region using the determined dimension of the first droplet region and calculating a volume of the second droplet region using the determined outer dimension of the second droplet region.

In an example, the first droplet region can be considered to be spherical and the determined dimension of the first droplet region can be the radius of the sphere. The spherical droplet volume may then be calculated using the determined radius. The second droplet region may be considered to be a spherical shell, and the determined outer dimension can be the outer radius of the spherical shell. The volume of the spherical shell may then be calculated using the determined radius of the first droplet region and the outer radius of the second droplet region.

In an alternative example, one or more outer dimensions (e.g. a width of the droplet region or a cross-sectional area of the droplet region) of the second droplet region may be limited by a known width or cross-sectional area of the microfluidic channel and another outer dimension of the second droplet region may be determined using the method as described above (e.g. a length of the droplet within the droplet channel). The first droplet region may be considered to be a sphere inside the outer droplet region, or may be considered to be concentric and have a similar shape, such that if a cross-sectional of the second droplet region is known, a cross-sectional area of the first droplet region can be calculated using the determined lengths of the first and second droplet regions. The volumes of the first and second droplet regions may be then calculated using the known width or cross-sectional area and the determined droplet dimensions.

According to a further aspect, there is provided a method of determining a total volume of fluid within a sequence of droplets within a flow of droplets, the method comprising: generating a flow of droplets as described above;
for each droplet within the flow of microfluidic droplets, calculating a volume of the first droplet region using the determined dimension of the first droplet region and calculating a volume of the second droplet region using the determined outer dimension of the second droplet region;
calculating an average volume of the first droplet regions and an average volume of the second droplet regions of the droplets;
determining a total volume of fluid within the first droplet regions using the droplet frequency and the average volume of the first droplet regions and determining a total volume of fluid within the second droplet regions of the droplets using the droplet frequency and the average volume of the second droplet regions.

Calculating a droplet volume for each droplet within the flow of droplets may comprise calculating a droplet volume for each imaged droplet within the flow. The method may comprise only imaging a proportion of the droplets within the flow, and therefore the droplet volume will not be calculated for droplets that are not imaged.

Calculating the average droplet volume may comprise calculating a rolling average of droplet volume of imaged droplets, and may include the most recent imaged droplets.

Determining a total volume of droplets may comprise determining a total volume of droplets over a given time period.

The method may further comprise increasing a pressure of the flow of said carrier fluid line in response to a determined total volume of fluid within the first droplet regions or within the second droplet regions being greater than a predetermined threshold value to inhibit droplet generation.

In this way, the user can specify the volume of emulsion that they want to collect, based on the sample size provided, and the machine will stop producing the emulsion when this value is achieved.

The method may comprise providing a third droplet fluid; forming a double emulsion of droplets each comprising a first droplet region comprising a mixture of the first droplet fluid and the third droplet fluid surrounded by a second droplet region comprising the second droplet fluid within the carrier fluid, by providing a flow of said first droplet fluid, a flow of said second droplet fluid, a flow of said third droplet fluid, and a flow of said carrier fluid to a droplet generation sub-system of a microfluidic structure; measuring a flow rate of the flow of said first droplet fluid and/or the flow of said third droplet fluid; determining a total volume of the first droplet regions of the droplets within the double emulsion of droplets; determining a ratio of the first droplet fluid and the third droplet fluid within the mixture using the measured flow rate and the total volume of the first droplet regions; and adjusting a pressure of the flow of the first droplet fluid and/or the flow of the third droplet fluid in response to the determined ratio.

The use of the image-based determination of inner droplet region volume and photodetector-based determination of the total flow rate of the first or third droplet fluids, plus the use of a flow sensor at one of the droplet fluid inlets, allows the production of monodisperse dual-aqueous double emulsion droplets having a defined mixture ratio between the two aqueous flows forming the inner droplet region.

The flow sensor may preferably be configured to measure the flow rate of the third droplet fluid, as the first droplet fluid may contain cells or fragile biological or chemical components.

This method can be used to maintain or control the cell occupancy in the production of monodisperse droplets having an inner droplet region formed of two droplet fluids: one of which including cells or particles, and the other being a diluent.

The method may further comprise providing a third droplet fluid; forming a double emulsion of droplets each comprising a first droplet region comprising a mixture of the first droplet fluid and the third droplet fluid surrounded by a second droplet region comprising the second droplet fluid within the carrier fluid, by providing a flow of said first droplet fluid, a flow of said second droplet fluid, a flow of said third droplet fluid, and a flow of said carrier fluid to a droplet generation sub-system of a microfluidic structure; calculating an average number of entities within the first droplet region of each droplet; and adjusting a pressure of the flow of the first droplet fluid or the flow of the third droplet fluid in response to the calculated average number of entities.

This method can also be used to maintain or control the cell occupancy in the production of monodisperse droplets inner droplet region formed of two droplet fluids: one of which including cells or particles, and the other being a diluent.

Forming a double emulsion of droplets may comprise providing the first droplet fluid, the third droplet fluid, and the second droplet fluid to a first droplet generation region of the droplet generation sub-system to form a single emulsion; and providing the single emulsion and the carrier fluid to a second droplet generation region of the droplet generation sub-system.

According to a further aspect there is provided a microfluidic system, comprising: a first droplet fluid line to carry a first droplet fluid;
a second droplet fluid line to carry a second droplet fluid;
a carrier fluid line to carry a carrier fluid;
a microfluidic droplet channel to carry a flow of droplets;
a droplet generation sub-system having a first input to receive a flow from the first droplet fluid line, having a second input to receive a flow from the second droplet fluid line, having a third input to receive a flow from the carrier fluid line, and having an output to the microfluidic droplet channel,
such that the droplet generation sub-system forms a double emulsion of droplets each comprising a first droplet region comprising the first droplet fluid surrounded by a second droplet region comprising the second droplet fluid within the carrier fluid; a camera configured to capture an image of droplets within the flow of droplets;
a processor configured to determine a dimension of said first droplet region of sequential droplets within the flow of droplets and configured to determine an outer dimension of said second droplet region of sequential droplets within the flow of droplets; means for adjusting the pressure of the first droplet fluid line or the second droplet fluid line in response to the determined dimension of the first droplet region; and
means for adjusting a pressure of the second droplet fluid line in response to the determined outer dimension of the second droplet region.

The droplet generation sub-system may comprise a first droplet generation region and a second droplet generation region, where the first droplet generation may comprise a first input to receive a flow from the first droplet fluid line and a second input to receive a flow from the second droplet fluid line, and an output to the second droplet generation region, and where the second droplet generation region may have a first input to receive a single emulsion from the first droplet generation region, a second input to receive a flow from the carrier fluid line, and an output to the microfluidic droplet channel.

The microfluidic system may further comprise a light source to illuminate the flow of microfluidic droplets with a beam of light comprising light having a range of wavelengths both above and below a predetermined threshold wavelength; a beam splitter configured to split light from the flow of microfluidic droplets into a first portion and a second portion; a camera configured to receive the first portion of the light; a photodetector configured to receive the second portion of the light; apparatus configured to process a signal from the photodetector; and a processor configured to determine a droplet frequency from fluctuations in the processed signal. The first portion may comprise light above the predetermined threshold wavelength and the second portion may comprise light below the predetermined threshold wavelength. An aperture may be located in front of the photodetector.

The processor may be configured to detect a droplet using the processed signal, and the camera may be configured to simultaneously capture an image of the droplet upon the detection of a droplet.

The camera may have an exposure time of 1 μs or less. This provides a high-speed area scanning camera, which can capture an image of a droplet in a microfluidic channel.

The aperture may comprise a slit corresponding to a band of light substantially perpendicular to sidewalls of the microfluidic droplet channel.

Alternatively, the aperture may comprise a pin-hole corresponding to a beam of light positioned substantially in the centre of the microfluidic droplet channel.

The aperture may comprise a mechanical slit which allows only a narrow band of light, perpendicular to the main microfluidic channel sidewalls, to reach the photodetector, and thus, increases detection sensitivity.

Alternatively, the aperture may comprise a crescent aperture configured to increase sensitivity of the photodetector.

The first portion may comprise light having a wavelength greater than 488 nm and the second portion may comprise light having a wavelength less than 488 nm.

The droplets may be microdroplets, nanodroplets, or picodroplets, or may be larger or smaller.

### BRIEF DESCRIPTION OF THE DRAWINGS

Some embodiments of the disclosure will now be described, by way of example only, and with reference to the accompanying drawings, in which:

FIG. 1 illustrates schematically an optomechanical assembly for imaging a microfluidic chip;

FIG. 2 shows an example of the optical assembly of FIG. 1;

FIG. 3 illustrates a method for identifying and determining a dimension of an inner droplet region and an outer droplet region of a droplet within a double emulsion;

FIG. 4 illustrates schematically a single-aqueous droplet generation sub-system for producing a double emulsion;

FIG. 5 illustrates schematically a flow focus junction and Y-junction within the double-emulsion droplet generation region shown in FIG. 4;

FIG. 6 illustrates schematically a droplet generation region for producing a double emulsion of dual-aqueous droplets; and

FIG. 7 illustrates schematically a dual-aqueous flow focus junction, serpentine mixing channel, the second flow focus junction and Y-junction within the double-emulsion droplet generation sub-systems shown in FIG. 6.

### DETAILED DESCRIPTION

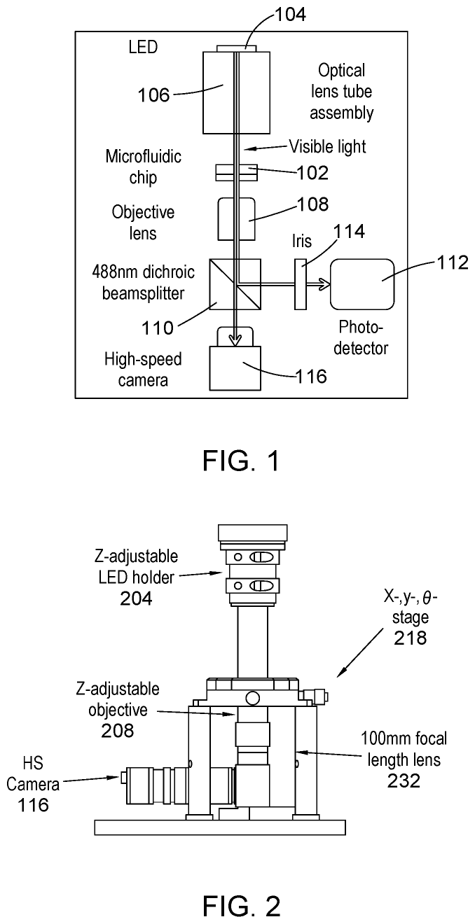

FIG. 1 illustrates schematically an optomechanical assembly for imaging a microfluidic chip, and FIG. 2 shows a side view of an example of the optical assembly of FIG. 1.

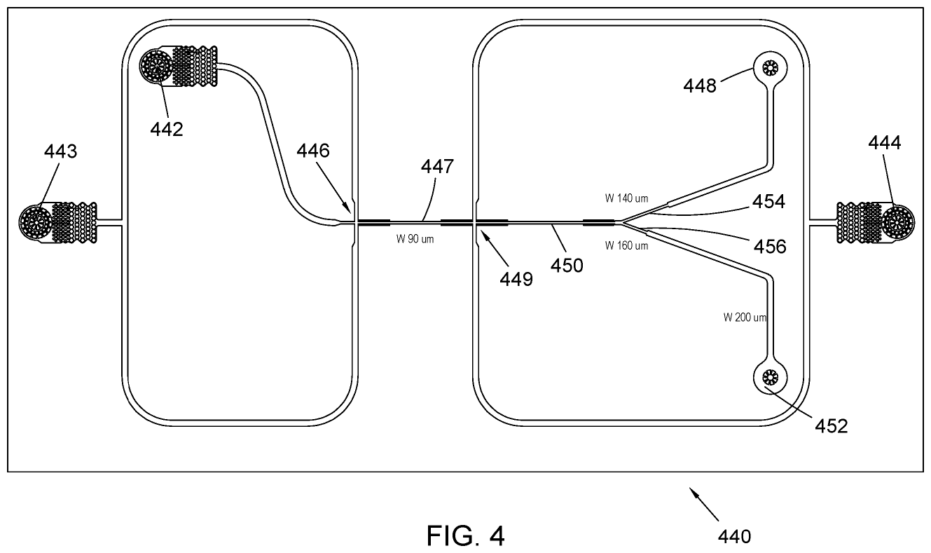

The optical assembly includes a microfluidic chip 102 having a microfluidic channel carrying a flow of microfluidic droplets. The droplets may be generated using the systems shown in FIGS. 4 to 7. An LED 104 attached to an optical lens tube assembly 106 is configured to illuminate the microfluidic chip 102 with light in the visible light spectrum. An objective lens 108 collects light from the microfluidic chip 104 and directs the light to a dichroic beam splitter 110.

The beam splitter 110 is configured to reflect a first portion of light from the beam splitter 110 to a photodetector 112. The beam splitter 110 is configured such that a second portion of light is transmitted from the beam splitter 110 to a high-speed camera 116.

In this example, the LED 104 is a white LED, and the beam splitter 110 is a dichroic mirror that splits an in-focus image of the flow of droplets into light portions above or below a predetermined wavelength (in this example, the wavelength is 488 nm such that blue light is directed to the photodetector). The beam splitter 110 directs approximately 20% of the light to the photodetector and 80% to the camera, however the split-ratio may be altered. The camera is not very sensitive in the blue region of visible light, and so the dichroic mirror directs the green and red portions of visible light to the camera to improve sensitivity. The blue light, which is of limited use to the camera, is directed to the photodetector.

Light having a wavelength below the predetermined wavelength (in this example, 488 nm) is reflected by the dichroic mirror 110 to a photodetector 112. An aperture 114 is located between the beam splitter 110 and the photodetector 112. The aperture 114 can be a mechanically adjustable slit (referred to as a slit-iris), a circular iris, a narrow rectangular aperture, or a crescent shaped aperture, that is set such that it allows only a narrow band of light from the main microfluidic channel to reach the photodetector.

Each droplet within the flow of droplets includes a first liquid droplet suspended in a carrier fluid. The droplet liquid may be a particle in an aqueous liquid and the carrier fluid may be a continuous oil phase. When the interface between the droplet and the carrier fluid passes over the photodetector 112, the voltage signal of the photodetector diminishes due to the light scattering. Once, the droplet has passed over the detector 112 and only the oil continuous phase is visible to the photodetector 112 the voltage increases and returns to the background signal. Each passing droplet within the microfluidic channel exhibits a decrease in the amplitude of the photodetector measured voltage signal, as the light intensity is momentarily scattered by the passing droplet. The incidence and repetition of such voltage decreases, which are each characteristic of the presence of individual flowing droplets, over time (i.e., 1 s time-scale) are then used to calculate droplet frequency. This arrangement increases the detection sensitivity of the photodetector and enables measurement of the droplet generation frequency continuously in real-time using custom, automated frequency detection software.

The light having a wavelength above the predetermined wavelength (in this example, 488 nm) is transmitted through the dichroic mirror 110 to the sensor of a high-speed area scan camera 116. To ensure that droplets are imaged at approximately the same area within the microfluidic channel, the photodetector voltage signal output is received and processed on a microprocessor. Upon receiving the photodetector voltage signal output, the microprocessor sends a trigger-signal to prompt camera image acquisition of a droplet using ultrashort exposure imaging. For example, when a passing droplet causes a decrease in the measured voltage signal amplitude which exceeds a custom-specified threshold, a software process is triggered which firstly waits a set delay time before triggering the acquisition of an image by the camera which has an exposure time of 1 μs or less.

The microprocessor camera triggering algorithm allows the droplet generation frequency to be calculated by counting the number of individual triggered signals sent to the camera over a set period of time, or since the last image was captured (i.e., where the image processing loop time exceeds the time between two adjacent droplet detection incidences).

The optical assembly may be provided as an inverted microscope, such as that shown in FIG. 2. The inverted microscope can be a semi-automated inverted microscope with white LED illumination, in which images of a microfluidic chip mounted on an x,y-translatable stage 218 can be continuously and simultaneously relayed to a silicon free-space amplified photodetector and a high-speed area scan camera. The translatable stage 218 may also be rotatable (Θ). The LED is mounted in a LED holder 204 that is adjustable in the z-direction. The LED holder 204 may also contain optical lenses that are adjustable in the z-direction. The objective lens 208 in the inverted microscope shown in this example is adjustable along the z-axis to allow an image of the microchip to be formed by a lens 232. In this example, the lens 232 has a focal length of 100 mm. The microfluidic chip can be a droplet generation chip as shown in FIGS. 4 to 7, including the output or collection channel of a microfluidic droplet generation and/or biological cell/particle encapsulation. The system enables downstream signal processing and subsequent regulation of the monodispersity of a produced emulsion containing droplets.

The instrument can be semi-automated; a human user may assemble a microfluidic chip to the macrofluidic connections and place the assembled fixture upon the instrument stage before navigating through the sequential, automated steps of the custom software-based workflow operations.

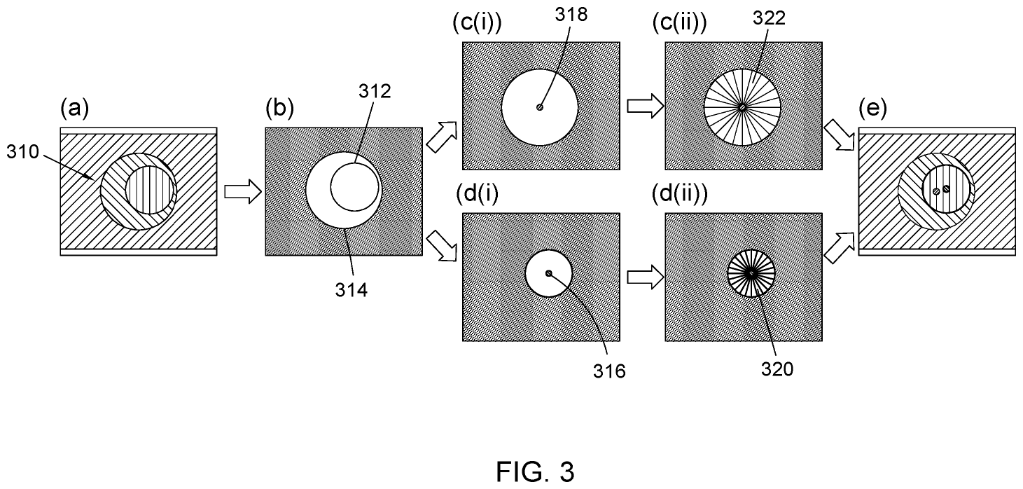

FIG. 3 illustrates a method for identifying and determining a dimension of an inner droplet region and an outer droplet region of a droplet within a double emulsion. In general a dimension refers to a measurement in one direction.

The method may be performed using an automated software process, which commences after the automated droplet production start-up procedure is complete. The method includes detecting the core and shell components (also referred to as the inner droplet region 312 and the outer droplet region 314) of the double emulsion droplets 310 within the imaged section of the microchannel, before determining the size of each the core and shell components 312, 314 of the droplets for the purpose of simultaneously inputting the size measurement data of the core and shell components into two independent closed-loop image based feedback loops which regulate the volume of the core or shell components 312, 314 of the droplets, respectively.

FIG. 3(a) shows a first step of capturing an image containing at least one double emulsion droplet 310 containing a core region 312 and a shell or sheath region 314. This may be performed by triggering an image acquisition from the processed photodetector output signal.

FIG. 3(b) shows a second step and involves processing the captured image by applying a threshold to the image to identify the boundaries of the image. A filter is then applied to the processed binary image to remove particulate noise that contacts the identified boundaries. Subsequently, identified objects not resistant to a custom number of erosions are filtered from the data stream, with steps taken to ensure that the remaining objects within the processed image, corresponding to an outside edge of the outer droplet region 312 and an outside edge of the inner droplet region 314, are the exact same shape as those found in the original captured image.

FIG. 3((c)i) and FIG. 3((d)i) shows a third step of processing the remaining identified objects in the processed image of FIG. 3(b) independently of each other, by creating and processing separate data streams corresponding to each remaining identified object. For each identified object 312, 314, the centre of the object 316, 318 is identified. Both separate data streams are processed simultaneously.

FIG. 3((c)ii) and FIG. 3((d)ii) shows a fourth step of, for each identified object 312, 314, a series of radii 320, 322 are constructed to identify the outer droplet region 312 (also referred to as the shell region) and the inner droplet region 314 (also referred to as the core region) edges, respectively.

To identify the outer droplet region 314 edge, the radii 322 are constructed in the direction from outside to inside (i.e., from the outside edge into the centre 318). The inner droplet region 312 edge is identified by constructing radii 320 in the direction from the centre 316 to the outside edge of the inner droplet region 312.

FIG. 3(e) shows a fifth step of independently constructing a boundary for each identified object 312, 314 by fitting a closed curve (in this example, an ellipse) to the outer extreme points of the constructed radii 320, 322 for each identified object. The constructed boundaries then identify two independent elliptical regions of interest, from which elliptic radius data is used to calculate size data for both the identified objects. The calculated size data for each identified object is then input into two independent closed feedback loops to simultaneously regulate the size of the core region 312 and the shell region 314 of droplets of the double emulsion and maintain the monodispersity of the double emulsion.

The object boundaries can be precisely constructed using the droplet radii data and then overlaid on the captured camera image in real-time to enable visual confirmation of droplet detection by the user. Further, radii data from each data stream can be used to calculate the size of the droplet core region or shell region respectively, which can in turn be used to as an input to other downstream processes.

FIG. 4 illustrates schematically a single-aqueous droplet generation region or sub-system 440 on a microfluidic chip that may be used with the optical assembly of FIG. 1. FIG. 4 shows a view of a single-dispersed phase inlet droplet generation region having Y-shaped sorting channels leading to the waste and/or collection channels. This can be used to provide an emulsion of droplets including aqueous core regions in a fluorous oil shell contained within an aqueous continuous phase. The droplet generation region includes an aqueous sample inlet channel 442, a sheath inlet channel 443, and a carrier fluid inlet channel 444 for generating the emulsion.

Flows of the aqueous sample fluid and the oil sheath fluid are provided to a first flow focus junction 446 of a droplet producing nozzle where a first emulsion of individual water-in-oil droplets is generated. The first flow focus junction 446 leads to a second flow focus junction 449 via a straight, first emulsion channel 447. The second flow focus junction 449 leads to a Y-shaped sorting channels.

Subsequently, the first emulsion and the carrier fluid (an aqueous continuous phase) are provided to a second flow focus junction 449 downstream of the first flow focus junction 446, to form double emulsion droplets. These are then provided to a collection channel 448 of the droplet generation region 440. The oil sheath fluid containing single aqueous droplets is encapsulated in an aqueous carrier fluid at the second flow-focus junction 449 to produce the double emulsion. By way of example, the carrier oil may have a flow rate of 1400 μl per hour, the aqueous sample, for example a cell suspension, may have a flow rate of 1000 μl per hour and the water-in-oil emulsion in the collection channel may have a flow rate of 2400 μl per hour comprising 700 picolitre droplets at 1000 Hz.

The sample inlet channel 442 is coupled to a first pressure controller (not shown), the sheath inlet channel 443 is connected to a second pressure controller (not shown), and the carrier fluid inlet channel 444 is coupled to a third pressure controller (not shown). The first, second, and third pressure controllers can be used to control the pressure within the sample fluid inlet channel 442, a sheath inlet channel 443, or the carrier fluid inlet channel 444.

In this example, the first droplet fluid (the sample fluid), the second droplet fluid (the sheath fluid) and the carrier fluid for each of the inner droplet region, the outer droplet region, and the continuous phase are delivered to the aqueous sample inlet channel 442, the sheath inlet channel 443, and the carrier oil inlet channel 444 via flexible tubing which is connected to a gas pressurized fluid reservoir, which in turn is actuated via a fast-acting pressure regulator. Upon automated software adjustment of the objective focus (z-direction) level via its associated stepper motor, an automated droplet production start-up software process is subsequently used to increase the pressure controlling the fluid flow of the sample inlet channel 442, the sheath inlet channel 443, and the carrier oil inlet channel 444 to begin double emulsion droplet production.

The calculated sizes (for example, droplet width or droplet volume) of the first droplet region and the second droplet region, as discussed above in relation to FIG. 3, can be used as the input to two separate feedback loops, which regulate the input pressure of one or more fluidic inlet lines 442, 443, 444 in response to the calculated sizes of the first droplet region and the second droplet region to maintain the monodispersity of the droplets within the emulsion.

The droplet volume as measured and calculated using a method as described above, can be averaged over a number of recent droplet volume measurements (e.g., 100 or less of the most recent measurements) to give an average measured droplet volume, which is then compared to the user-defined desired or requested droplet volume.

The error (σ), or difference, in average measured droplet volume compared to the desired droplet volume, is then used to modulate the voltage supplied to at least one of the first, second, or third pressure controllers (these can be voltage-activated pressure controllers) which enforces a change in supply pressure of one or more of the fluidic inlet lines 442, 443, 444.

For example, where the average measured droplet volume is found to be lower than the user-desired droplet volume, then the voltage supplied to the relevant pressure controller(s) is gradually altered within a feedback loop(s) to enforce an increase in the droplet volume. Similarly, where the average droplet volume is greater than the wanted droplet volume then the voltage supplied to the relevant pressure controller(s) is gradually altered within a feedback loop(s) to enforce a decrease in the droplet volume.

Droplet volume measurements can be integrated over a sub-second timescale, e.g., 0.1-0.5 s to reduce the effects of outliers.

The change in pressure applied to a fluidic inlet line, A, is governed by the feedback equation:

$$Δ = {K}_{p} σ + {K}_{i} + \int σ dt + {K}_{d} \frac{d}{dt} σ$$

where Kₚ, Kᵢ and K_{d} are the proportional, integral, and derivative constants, which describe the current, past, and future behaviour of the feedback, respectively. The value of Kₚ reacts proportionally to any change in the error reducing the rise time of any steady state errors. Kᵢ reacts to and reduces long term, steady state errors, while K_{d} is based on the rate of change of the error and reduces overshoots in the response of the feedback.

Due to the sub-second timescales used when considering the error in droplet volume measurements, the term Kₚ, which relates to the current behaviour of the feedback, is the dominant term in the feedback response in most practical cases. Therefore, an error, σ, would result in a pressure change of Δ=Kₚσ and so Pₙ₊₁=Pₙ+Δ, where Pₙ is the initial pressure supplied from the pressure regulator and Pₙ₊₁ is the new, updated supply pressure at a later time. However, in other cases, such as where droplet volume measurements are averaged over larger timescales, the terms Kₚ, and/or Kᵢ, and/or K_{d} may be used as the input to the feedback routine of the system to respond to error, as defined previously.

A system, including the optical assembly shown in FIG. 1 having a microfluidic chip including the droplet generation region of FIG. 4, may perform an automated process of the steps discussed above to use photodetector-based detection of the presence of individual droplets in a microfluidic flow to initiate the triggered capturing of droplet images at a specified area within the microfluidic channel.

As discussed above, the automated process then includes image processing to identify the centre of flowing droplets within the microchannel to define two elliptical regions of interest (ROIs) within the gathered camera images—with one ROI corresponding to the core region and a second ROI corresponding to the shell region of each droplet. The use of an automated, software-based method of defining a ROI removes a significant amount of error that would normally be associated with the manual positioning of the ROI from a human user and thus increases the precision of the droplet size estimation method versus previously reported systems. Further, the use of only data from the two regions of interest, rather than a full image, significantly reduces processing time and thus increases the possible throughput of the system. The image data from each ROI is used to calculate droplet size, which is in turn then used as the input to a feedback loop which regulates the input pressure of the core and shell fluidic inlet lines to maintain the monodispersity of the double emulsion.

The image-derived individual droplet size data may be used to then calculate average or individual sizes (for example, droplet width or volume) of the first droplet region and the second droplet region and input the calculated average size data into two closed feedback loops that maintain the monodispersity of a double emulsion by controlling the pressure of the sample inlet channel 442, the sheath inlet channel 443, and/or the carrier oil inlet channel 444 in response to the calculated droplet size data.

A closed-loop image-based feedback routine is then initiated, whereby image data from sequential images is processed, as described previously, to measure droplet size data and subsequently regulate the input pressure(s) of one or more input fluid lines to maintain droplet monodispersity within a double emulsion over the duration of the emulsion production run.

The product of average frequency during a given period of image acquisition and the average core region and shell region volumes during the same period is a good approximation of the volume of sample consumed in the droplet, the sum of which can be continuously updated. Using the determined average droplet volume and the photodetector-derived average droplet generation frequency, then the volume of droplets within the produced emulsion can be calculated. When the volume of produced emulsion is equal to or exceeds a user-specified target volume, automated software is initiated which increases the pressure of the carrier oil inlet channel 444 to, firstly, limit further fluid flow from the sample inlet channel 442 and the sheath inlet channel 443 and, secondly, to clear the last produced droplets from the microfluidic chip to the emulsion reservoir, to make the produced emulsion physically available to the user. In this way, the user can specify the volume of emulsion that they want to collect, based on the sample size provided and the machine will stop producing the emulsion when this value is achieved.

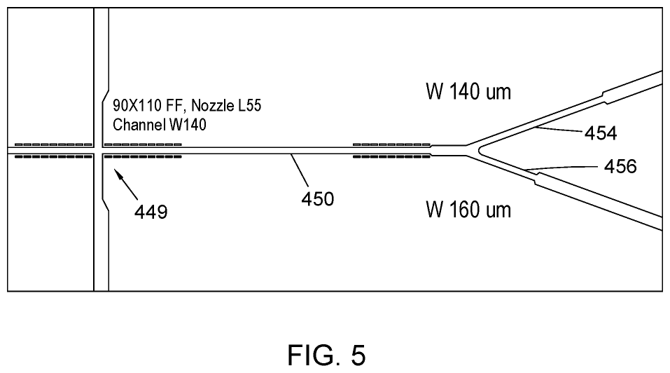

The second flow focus junction 449 is also coupled to a waste channel 452, as shown in FIGS. 4 and 5. FIG. 5 shows the second flow focus junction 449, a straight, second emulsion channel 450, and a Y-shaped sorting junction with channels 454, 456, leading to both waste 452 and collection 448 within the droplet generation region of FIG. 4.

The emulsion formed at the second flow focus junction 449 flows through the second emulsion channel 450, and to a Y-junction having two outputs 454, 456. When the instrument is started-up, there may be a time period in which the droplets that are being generated do not meet the specified user's size requirements. Generally, this may be a period of ten or more seconds.

The first output 454 has a narrower width and is located between the flow-focus junction 446 and the collection channel 448. The second output 456 has a larger width and is located between the flow-focus junction 446 and the waste channel 452. Whilst the droplets that are being generated do not meet the specified user's size requirements, this microfluidic chip would allow these droplets to travel to the waste channel 452, and only when the correct droplet size is achieved would a memory shape valve (not shown) on the waste channel 452 be closed. In an example, the valve has been programmed to shut over a period of 1 second, but the rate of closure can be changed. By closing the valve of the waste channel 452 relatively slowly, this allows the system to compensate for the increased back pressure in the system without the droplet volume changing.

In this example, the sample inlet channel 442, the sheath inlet channel 443, and the carrier fluid inlet 444 are spaced relatively far apart from each other and from the collection and waste channels 448, 452. This allows a cell or oil sample reservoirs, such as syringe bodies, to be mounted directly to the chip using Luer-Lok™ fittings.

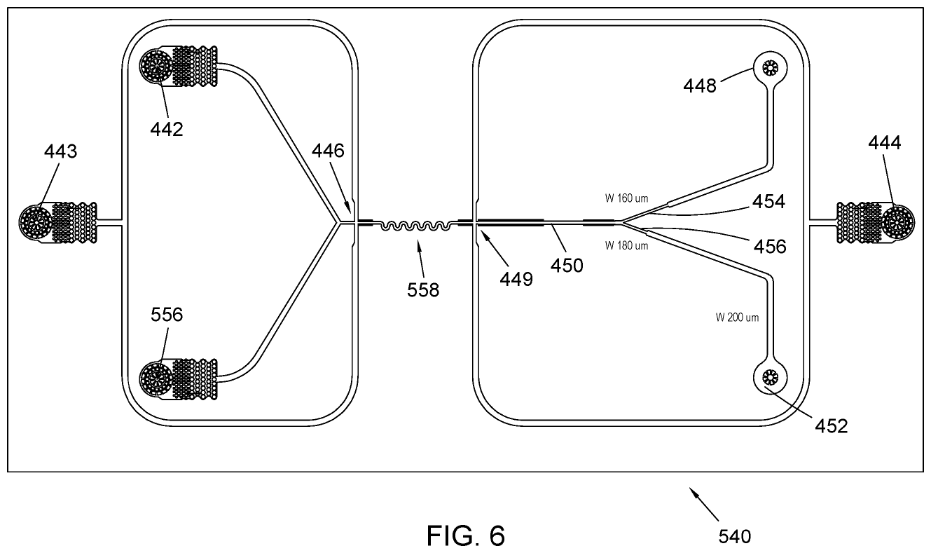

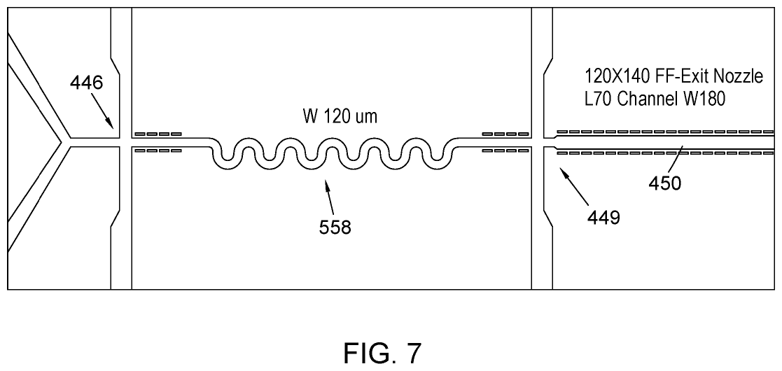

FIG. 6 illustrates schematically a droplet generation region 540 for dual-aqueous emulsion generation. FIG. 6 shows a view of a dual-dispersed phase droplet generator-sorting chip design for producing a double emulsion of dual dispersed phase droplets and FIG. 7 shows the first and second flow focus junctions 446, 449 and the serpentine channel region 558 of the droplet generation region 540 of FIG. 6. The first emulsion channel is a serpentine channel region 558 having a sinusoidal shape and located between the first and second flow focus junctions 446, 449. This serpentine channel 558 aids droplet mixing of the dual-dispersed phase mixture within the droplets by inducing a tumbling effect within the droplets as they traverse the serpentine channel 558. In the example shown, the serpentine channel 558 has a width of 120 μm.

Dual-aqueous droplets are droplets having a core region formed of a mixture of two aqueous fluids. The fluids may both comprise sample fluids, or one of the fluids may be a sample fluid and the other fluid used to dilute the sample fluid of the mixture within the droplets. The droplet generation region 540 is similar to that shown in FIG. 4, however the droplet generation region also includes a second sample fluid inlet 556. The two laminar aqueous inlet fluids can converge just prior to the first flow focus junction 446 and are encapsulated in immiscible fluorous sheath oil at the first flow focus junction 446 to produce a first emulsion of individual water-in-oil droplets. The serpentine channel 558 aids mixing in the first emulsion. Subsequently, the first emulsion and the carrier fluid (an aqueous continuous phase) are provided to a second flow focus junction 449 downstream of the first flow focus junction 446, to form double emulsion droplets. Finally, the double emulsion passes to a Y-shaped junction which allows the produced double-emulsion to travel either to a waste channel (456) or to a collection channel (454) with channels, leading to both a waste outlet 452 and a collection outlet 448.

A fourth pressure controller is used to control the pressure of fluid flow within the second sample fluid inlet 556 from an additional reservoir containing a second aqueous sample.

A liquid flow sensor (not shown) is placed to measure the flow along one or more of the aqueous inlets 442, 556. By measuring the total aqueous sample flow rate for a minimum of one of the sample inlet lines, the calculated average inner droplet region volume, and the droplet frequency, then the mixture ratio between the two aqueous inlet samples within the formed droplets can be estimated in real-time. This is performed by
(i) multiplying the droplet frequency (also referred to as the droplet generation rate) by the calculated rolling average inner droplet region volume to calculate the total volumetric inner droplet region flow rate of the system (e.g., in units μL s⁻¹), and;
(ii) subtracting the measured sensor-based volumetric flow rate of one aqueous inlet line 442, 556, measured using the liquid sensor 560, and
(iii) calculating the following ratio: flow-sensor based volumetric flow rate of a single inlet line/(total volumetric inner droplet region flow rate of the system).

The first and fourth pressure controllers can be used to control the pressure within the sample fluid inlets 442, 556 in response to the estimated mixture ratio within the formed droplets. This allows the mixture ratio of the two sample fluids within the droplets to be regulated in real-time. This provides a closed-loop image-based feedback loop, to produce a monodisperse emulsion of droplets having aqueous core regions surrounded by an oil sheath region, in an aqueous encapsulating fluid with a user-defined mixture ratio between the two inlet fluids and a user-defined droplet volume. Further, the mixture ratio can be maintained at a constant level, or the mixture ratio can be defined to change over a certain time period.

Image analysis from the image of a produced droplet may be used to count the number of contained microparticles (including biological cells) within each individual droplet. The average biological cell/object-occupancy of droplets may be monitored. The first and fourth pressure controllers can be used to control the pressure within the sample fluid inlets 442, 556 in response to the average biological cell/object-occupancy of droplets. In this way, the device provides a closed-loop feedback system, where the average biological cell/object-occupancy of droplets is used as the input to the feedback loop to regulate the mixture ratio between the two inlet aqueous fluids (for example, a first aqueous sample fluid may be a particle or cell-laden solution and the second aqueous sample fluid may be a compatible buffer solution). Adjustment of this mixture ratio allows the average particle or cell occupancy to be controlled during an experimental run to compensate for particle or cell sedimentation, high particle or cell concentration, or other forms of drift.

Whilst the examples shown relates to droplets within a microfluidic chip, it will be appreciated that the device is not limited to droplets (the volume of which is generally below approximately one thousand or a few thousand picolitres), and is applicable to droplets of other sizes (for example, droplets may be larger or smaller, giving a volume which may be in the range nanolitres to femtolitres).

We have described techniques which, in preferred embodiments, are applied to processing droplets of a water-in-oil-in-water double emulsion containing biological entities. In principle however non-biological entities, such as organic or inorganic materials, may be processed in a similar manner. Likewise, the techniques we describe are also in principle applicable to processing droplets of oil samples in oil-in-water-in-oil double emulsions.

No doubt many other effective alternatives will occur to the skilled person. It will be understood that the invention is not limited to the described embodiments and encompasses modifications apparent to those skilled in the art lying within the spirit and scope of the claims appended hereto.

Reference Numerals

| | |
|---|---|
| 102 | Microfluidic chip |
| 104 | LED |
| 106 | Optical lens tube assembly |
| 108 | Objective lens |
| 110 | Beam splitter |
| 112 | Photodetector |
| 114 | Iris aperture |
| 116 | High speed camera |
| 204 | z-adjustable LED holder |
| 208 | z-adjustable objective lens |
| 218 | x-y-Θ translatable stage |
| 232 | Lens |
| 310 | Droplet |
| 312 | Inner droplet region |
| 314 | Outer droplet region |
| 316 | Centre of inner droplet region |
| 318 | Centre of outer droplet region |
| 320 | Radii of inner droplet region |
| 322 | Radii of outer droplet region |
| 440 | Droplet generation region |
| 442 | Sample fluid inlet |
| 443 | Sheath fluid inlet |
| 444 | Carrier fluid inlet |
| 446 | First flow focus junction |
| 447 | First emulsion channel |
| 449 | Second flow focus junction |
| 450 | Second emulsion channel |
| 448 | Collection channel |
| 452 | Waste channel |
| 454 | First output |
| 456 | Second output |
| 540 | Droplet generation region |
| 556 | Second sample fluid inlet |
| 558 | First emulsion channel |

1. A method for generating a flow of droplets, the method comprising:
providing a first droplet fluid;
providing a second droplet fluid;
providing a carrier fluid;
forming a double emulsion of droplets each comprising a first droplet region comprising the first droplet fluid surrounded by a second droplet region comprising the second droplet fluid within the carrier fluid, by providing a flow of said first droplet fluid, a flow of said second droplet fluid, and a flow of said carrier fluid to a droplet generation sub-system of a microfluidic structure;
determining a dimension of said first droplet region of sequential droplets within the emulsion;
determining an outer dimension of said second droplet region of sequential droplets within the emulsion;
adjusting a pressure of the flow of the first droplet fluid in response to the determined dimension of the first droplet region; and
adjusting a pressure of the flow of the second droplet fluid in response to the determined outer dimension of the second droplet region.

2. A method according to claim 1, wherein forming a double emulsion of droplets comprises:
providing the first droplet fluid and the second droplet fluid to a first droplet generation region of the droplet generation sub-system to form a single emulsion; and
providing the single emulsion and the carrier fluid to a second droplet generation region of the droplet generation sub-system.

3. A method according to claim 1, comprising varying a pressure of the flow of the first droplet fluid, varying a pressure of the flow of the second droplet fluid, and/or varying a pressure of the flow of said carrier fluid such that a determined dimension of said first droplet region or a determined outer dimension of said second droplet region is substantially constant between sequential droplets.

4. A method according to claim 1, wherein determining a dimension of said first droplet region or determining an outer dimension of said second droplet region comprises determining a dimension from a captured image of the droplet.

5. A method according to claim 4, further comprising:
detecting a droplet of the flow of droplets within a microfluidic droplet channel; and
upon detection of the droplet, capturing an image of the droplet using a camera to provide the captured image of the droplet.

6. A method according to claim 5, wherein detecting a droplet within the flow of droplets comprises:
illuminating the flow of droplets within the microfluidic droplet channel;
using a beam splitter to split light from the flow of droplets into a first portion and a second portion, wherein the first portion comprises light above a predetermined threshold wavelength and wherein the second portion comprises light below a predetermined threshold wavelength;
directing the first portion to the camera for capturing an image of the droplet using the camera;
directing the second portion through an aperture located in front of a photodetector to the photodetector; and
processing a signal from the photodetector to provide a processed signal for detecting a droplet of the flow of droplets within a microfluidic droplet channel, and determining a droplet frequency from fluctuations in the processed signal.

7. A method according to claim 6, wherein detecting a droplet within the flow of droplets comprises detecting scattered light from the second portion at the photodetector, wherein the scattered light has been scattered by an interface between the carrier fluid and second droplet region or scattered by an interface between the first droplet region and the second droplet region.

8. A method according to claim 4, wherein determining the droplet dimension comprises:
identifying a centre of the first droplet region and a centre of the second droplet region within the captured image of the flow;
fitting a first closed curve to an outside edge of the first droplet region in the captured image of the flow;
determining a first interest region in the captured image of the flow, wherein the first interest region comprises the centre of the first droplet region and wherein a perimeter of the first interest region corresponds to the first closed curve;
fitting a second closed curve to an outside edge of the second droplet region in the captured image of the flow;
determining a second interest region in the captured image of the flow, wherein the second interest region comprises the centre of the second droplet region and wherein a perimeter of the second interest region corresponds to the second closed curve; and
determining the droplet dimension by processing the first interest region and the second interest region of the captured image.

9. A method according to claim 1, further comprising calculating a volume of the first droplet region using the determined dimension of the first droplet region and calculating a volume of the second droplet region using the determined outer dimension of the second droplet region.

10. A method of determining a total volume of fluid within a sequence of droplets within a flow of droplets, the method comprising:
generating a flow of droplets according to claim 6;
for each droplet within the flow of microfluidic droplets, calculating a volume of the first droplet region using the determined dimension of the first droplet region and calculating a volume of the second droplet region using the determined outer dimension of the second droplet region;
calculating an average volume of the first droplet regions and an average volume of the second droplet regions of the droplets;
determining a total volume of fluid within the first droplet regions using the droplet frequency and the average volume of the first droplet regions and determining a total volume of fluid within the second droplet regions of the droplets using the droplet frequency and the average volume of the second droplet regions.

11. A method according to claim 10, further comprising increasing a pressure of the flow of said carrier fluid line in response to a determined total volume of fluid within the first droplet regions or within the second droplet regions being greater than a predetermined threshold value to inhibit droplet generation.

12. A method according to claim 1, comprising:
providing a third droplet fluid;
forming a double emulsion of droplets each comprising a first droplet region comprising a mixture of the first droplet fluid and the third droplet fluid surrounded by a second droplet region comprising the second droplet fluid within the carrier fluid, by providing a flow of said first droplet fluid, a flow of said second droplet fluid, a flow of said third droplet fluid, and a flow of said carrier fluid to a droplet generation sub-system of a microfluidic structure;
measuring a flow rate of the flow of said first droplet fluid and/or the flow of said third droplet fluid;
determining a total volume of the first droplet regions of the droplets within the double emulsion of droplets;
determining a ratio of the first droplet fluid and the third droplet fluid within the mixture using the measured flow rate and the total volume of the first droplet regions; and
adjusting a pressure of the flow of the first droplet fluid and/or the flow of the third droplet fluid in response to the determined ratio.

13. A method according to claim 1, comprising:
providing a third droplet fluid;
forming a double emulsion of droplets each comprising a first droplet region comprising a mixture of the first droplet fluid and the third droplet fluid surrounded by a second droplet region comprising the second droplet fluid within the carrier fluid, by providing a flow of said first droplet fluid, a flow of said second droplet fluid, a flow of said third droplet fluid, and a flow of said carrier fluid to a droplet generation sub-system of a microfluidic structure;
calculating an average number of entities within the first droplet region of each droplet; and
adjusting a pressure of the flow of the first droplet fluid or the flow of the third droplet fluid in response to the calculated average number of entities.

14. A method according to claim 12, wherein forming a double emulsion of droplets comprises:
providing the first droplet fluid, the third droplet fluid, and the second droplet fluid to a first droplet generation region of the droplet generation sub-system to form a single emulsion; and
providing the single emulsion and the carrier fluid to a second droplet generation region of the droplet generation sub-system.

15. A microfluidic system, comprising:
a first droplet fluid line to carry a first droplet fluid;
a second droplet fluid line to carry a second droplet fluid;
a carrier fluid line to carry a carrier fluid;
a microfluidic droplet channel to carry a flow of droplets;
a droplet generation sub-system having a first input to receive a flow from the first droplet fluid line, having a second input to receive a flow from the second droplet fluid line, having a third input to receive a flow from the carrier fluid line, and having an output to the microfluidic droplet channel,
such that the droplet generation sub-system forms a double emulsion of droplets each comprising a first droplet region comprising the first droplet fluid surrounded by a second droplet region comprising the second droplet fluid within the carrier fluid;
a camera configured to capture an image of droplets within the flow of droplets;
a processor configured to determine a dimension of said first droplet region of sequential droplets within the flow of droplets and configured to determine an outer dimension of said second droplet region of sequential droplets within the flow of droplets;
means for adjusting the pressure of the first droplet fluid line or the second droplet fluid line in response to the determined dimension of the first droplet region; and
means for adjusting a pressure of the second droplet fluid line in response to the determined outer dimension of the second droplet region.

16. A microfluidic system according to claim 15, wherein the droplet generation sub-system comprises:
a first droplet generation region and a second droplet generation region, wherein the first droplet generation comprises a first input to receive a flow from the first droplet fluid line and a second input to receive a flow from the second droplet fluid line, and an output to the second droplet generation region, and
wherein the second droplet generation region has a first input to receive a single emulsion from the first droplet generation region, a second input to receive a flow from the carrier fluid line, and an output to the microfluidic droplet channel.
